(19) United States
(12) Patent Application Publication
(10) Pub. No.: US 2026/0180275 A1
(43) Pub. Date: Jun. 25, 2026

(54) CHAMBER APPARATUS FOR LASER, LASER APPARATUS, AND ELECTRONIC DEVICE MANUFACTURING METHOD

(71) Applicant: Gigaphoton Inc., Tochigi (JP)

(72) Inventor: Ryota ITO, Oyama-shi (JP)

(73) Assignee: Gigaphoton Inc., Tochigi (JP)

(21) Appl. No.: 19/377,418

(22) Filed: Nov. 3, 2025

(30) Foreign Application Priority Data
Dec. 20, 2024 (JP) 2024-225852

(51) Int. Cl. H01S 3/034; H01S 3/036

(52) U.S. Cl. CPC H01S 3/034; H01S 3/036

(57) ABSTRACT

A chamber apparatus for a laser includes a chamber, a first optical path tube, a window, a resonance vessel, and a nozzle tube. In the chamber, a pair of discharge electrodes are disposed. The first optical path tube communicates with the chamber. The window is configured such that light is incident thereon from a region between the discharge electrodes via an interior of the first optical path tube. The nozzle tube is configured to cause the interior of the first optical path tube to communicate with the resonance vessel.

### CROSS-REFERENCE TO RELATED APPLICATIONS

The present application claims the benefit of Japanese Patent Application No. 2024-225852, filed on Dec. 20, 2024, the entire contents of which are hereby incorporated by reference.

### BACKGROUND

### 1. Technical Field

The present disclosure relates to a chamber apparatus for a laser, a laser apparatus, and an electronic device manufacturing method.

### 2. Related Art

In recent years, a semiconductor exposure apparatus is required to improve the resolution thereof as semiconductor integrated circuits are increasingly miniaturized and highly integrated. To this end, reduction in the wavelength of light emitted from a light source for exposure is underway. For example, a KrF excimer laser apparatus, which outputs laser light having a wavelength of about 248 nm, and an ArF excimer laser apparatus, which outputs laser light having a wavelength of about 193 nm, are used as a gas laser apparatus for exposure.

Excimer laser light output from a KrF excimer laser apparatus and excimer laser light output from an ArF excimer laser apparatus each have a pulse width of a few tens of nanoseconds, have short wavelengths of about 248 nm and about 193 nm, respectively, and are therefore used for direct processing of polymer materials, glass materials, and the like. The excimer laser light having photon energy higher than the chemical binding energy of a polymer material can unbind the chemically bonded molecules that form the polymer material. It is therefore known that the excimer laser light allows non-thermal processing of a polymer material, and that the non-thermal processing provides an excellent processed shape. Glass, ceramic, and other materials absorb excimer laser light by a large amount, and it is therefore known that excimer laser light can process such a material difficult to process with visible or infrared laser light.

### CITATION LIST

### Patent Literature

[PTL 1] U.S. Pat. No. 5,027,366

### SUMMARY

A laser chamber apparatus according to an aspect of the present disclosure includes a chamber, a first optical path tube, a window, a resonance vessel, and a nozzle tube. In the chamber, a pair of discharge electrodes are disposed. The first optical path tube communicates with the chamber. The window is configured such that light is incident thereon from a region between the discharge electrodes via an interior of the first optical path tube. The nozzle tube is configured to cause the interior of the first optical path tube to communicate with the resonance vessel.

An electronic device manufacturing method according to another aspect of the present disclosure includes: generating laser light by using a laser apparatus; performing laser processing on an interposer substrate with the laser light to produce an interposer; coupling the interposer to an integrated circuit chip to electrically connect the interposer to the integrated circuit chip; and coupling the interposer to a circuit substrate to electrically connect the interposer to the circuit substrate. The laser apparatus includes an optical cavity, a chamber, a first optical path tube, a window, a resonance vessel, and a nozzle tube. In the chamber, a pair of discharge electrodes are disposed. The first optical path tube communicates with the chamber. The window is located in an optical path of the optical cavity. The window is configured such that light is incident thereon from a region between the discharge electrodes via an interior of the first optical path tube. The nozzle tube is configured to cause the interior of the first optical path tube to communicate with the resonance vessel.

### BRIEF DESCRIPTION OF DRAWINGS

Some embodiments of the present disclosure will be described below only by way of example with reference to the accompanying drawings.

FIG. 1 shows the configuration of a laser processing system in Comparative Example.

FIG. 2 shows graphs illustrating results of a simulation of the magnitude of sound pressure of acoustic waves in the vicinities of windows in a case where baffles are not provided and in a case where the baffles are provided.

FIG. 3 shows the configuration of a laser processing system in a first embodiment.

FIG. 4 shows various parameters that determine a Helmholtz resonance frequency.

FIG. 5 shows graphs illustrating results of a simulation of the magnitude of the sound pressure of the acoustic waves in the vicinities of the windows in a case where Helmholtz resonators are not provided and in a case where the Helmholtz resonators are provided.

FIG. 6 shows the configuration of a Helmholtz resonator in a second embodiment.

FIG. 7 is a cross-sectional view of the Helmholtz resonator taken along the line VII-VII in FIG. 6.

FIG. 8 shows the configuration of a Helmholtz resonator in a third embodiment.

FIG. 9 shows a first example of the configuration of a Helmholtz resonator in a fourth embodiment.

FIG. 10 shows a second example of the configuration of the Helmholtz resonator in the fourth embodiment.

FIG. 11 shows the configuration of a Helmholtz resonator in a fifth embodiment.

FIG. 12 shows a first specific configuration of the Helmholtz resonator in the fifth embodiment.

FIG. 13 shows a second optical path tube and a second unit taken in a plane perpendicular to the traveling direction of light in the first specific configuration.

FIG. 14 shows a second specific configuration of the Helmholtz resonator in the fifth embodiment.

FIG. 15 shows the second optical path tube and the second unit taken in a plane perpendicular to the traveling direction of the light in the second specific configuration.

FIG. 16 shows a third specific configuration of the Helmholtz resonator in the fifth embodiment.

FIG. 17 shows the second optical path tube and the second unit taken in a plane perpendicular to the traveling direction of the light in the third specific configuration.

FIG. 18 shows a fourth specific configuration of the Helmholtz resonator in the fifth embodiment.

FIG. 19 shows the second optical path tube and the second unit taken in a plane perpendicular to the traveling direction of the light in the fourth specific configuration.

FIG. 20 diagrammatically shows the configuration of an electronic device.

FIG. 21 is a flowchart showing a method for manufacturing the electronic device.

### DETAILED DESCRIPTION

### Contents

1. Comparative Example
1.1 Laser processing system
1.2 Operation
1.3 Problems with Comparative Example
2. Chamber apparatus for laser in which resonance vessels 16a and 16b are connected to first optical path tubes 12a and 12b respectively
2.1 Configuration
2.2 Helmholtz resonance frequency f
2.3 Effects
3. Chamber apparatus for laser in which first unit 13c is disposed in second optical path tube 20
3.1 Configuration
3.2 Effects
4. Chamber apparatus for laser in which multiple first units 13c to 13e are disposed in second optical path tube 20
4.1 Configuration
4.2 Effects
5. Chamber apparatus for laser in which second optical path tube 20 defines resonance vessel 16f
5.1 Configuration
5.2 Effects
6. Chamber apparatus for laser in which volume V of resonance vessel 16h is fixed
6.1 Configuration
6.2 Effects
7. Others
7.1 Electronic device including interposer IP
7.2 Supplements

Embodiments of the present disclosure will be described below in detail with reference to the drawings. The embodiments described below show some examples of the present disclosure and are not intended to limit the contents of the present disclosure. Furthermore, all configurations and operations described in the embodiments are not necessarily essential as configurations and operations in the present disclosure. Note that the same element has the same reference character, and that no redundant description of the same element will be made.

### 1. Comparative Example

### 1.1 Laser Processing System

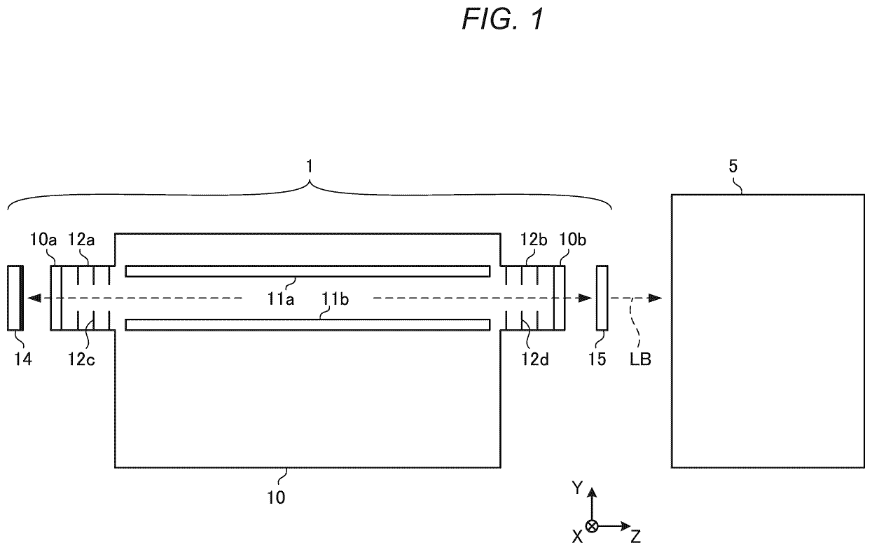

FIG. 1 shows the configuration of a laser processing system in Comparative Example. Comparative Example of the present disclosure is an aspect that the applicant is aware of as known only by the applicant, and is not a publicly known example that the applicant is self-aware of. The laser processing system includes a laser apparatus 1 and a laser processing apparatus 5.

The laser apparatus 1 is a discharge-pumped gas laser apparatus capable of outputting laser light LB to the laser processing apparatus 5. The laser processing apparatus 5 may be a semiconductor exposure apparatus or a processing apparatus that processes materials such as polymer and glass.

The laser apparatus 1 includes a chamber 10, windows 10a and 10b, first optical path tubes 12a and 12b, a rear mirror 14, and an output coupling mirror 15. A pair of discharge electrodes 11a and 11b are disposed in the chamber 10. A pulse power supply that is not shown is connected to the discharge electrodes 11a and 11b. The chamber 10 communicates with the first optical path tubes 12a and 12b, and the windows 10a and 10b are supported by the first optical path tubes 12a and 12b, respectively. The first optical path tubes 12a and 12b may be configured with holders that hold the windows 10a and 10b.

The rear mirror 14 is configured with a highly reflective mirror, and the output coupling mirror 15 is configured with a partially reflective mirror. The rear mirror 14 and the output coupling mirror 15 form an optical cavity. A line narrowing module including a wavelength selector may be disposed in place of the rear mirror 14. The chamber 10 is so disposed that the windows 10a and 10b are located in the optical path of the optical cavity.

The traveling direction of the laser light LB output via the output coupling mirror 15 is called a Z direction. The discharge electrodes 11a and 11b each extend in the Z direction. The direction in which the discharge electrodes 11a and 11b face each other is called a Y direction or a-Y direction. The Z direction and the Y direction are perpendicular to each other, and the direction perpendicular to the Z and Y directions is called an X direction or a-X direction. FIG. 1 shows the configuration of the laser apparatus 1 viewed in the X direction.

The chamber 10 encapsulates a laser gas containing, for example, an argon or krypton gas as a rare gas, a fluorine gas as a halogen gas, and a neon gas as a buffer gas. The chamber 10 may instead encapsulate a laser gas containing a fluorine gas and a buffer gas.

### 1.2 Operation

Discharge occurs between the discharge electrodes 11a and 11b when the pulse power supply applies a high voltage to the space between the discharge electrodes 11a and 11b. The energy of the discharge excites a laser medium in the chamber 10, so that the state of the excited laser medium transitions to a high energy level. Thereafter, when the excited laser medium transitions to a low energy level, the laser medium emits light having a wavelength according to the difference between the energy levels.

The light generated in the discharge space between the discharge electrodes 11a and 11b is incident on the windows 10a and 10b via the interior of the first optical path tubes 12a and 12b, and passes through the windows 10a and 10b. The rear mirror 14 reflects the light having exited via the window 10a at high reflectance and returns the reflected light to the chamber 10. The output coupling mirror 15 transmits and outputs part of the light having exited via the window 10b and reflects the other part of the light back into the chamber 10.

The light generated in the discharge space thus travels back and forth between the rear mirror 14 and the output coupling mirror 15. The light is amplified whenever passing through the discharge space. The light thus having undergone the laser oscillation and having been amplified is output as the laser light LB via the output coupling mirror 15 and enters the laser processing apparatus 5.

1.3 Problems with Comparative Example

The discharge between the discharge electrodes 11a and 11b causes components of the laser gas, components of the discharge electrodes 11a and 11b, and other components to undergo a chemical reaction to produce discharge products. The discharge products may adhere to the windows 10a and 10b, and result in the following disadvantages: (a) The transmittance of the windows 10a and 10b may decrease, so that the pulse energy of the laser light LB may decrease. (b) The discharge products having adhered to the windows 10a and 10b absorb the energy of the light. The temperature of the windows 10a and 10b thus increases, so that strain is produced to change the angle of incidence of the light, resulting in changes in the degree of polarization of the laser light LB and the transmittance of the windows 10a and 10b for the laser light LB. The windows 10a and 10b may instead be damaged.

To suppress the adherence of the discharge products to the windows 10a and 10b, the following measures are conceivable: (c) The laser gas in the chamber 10 is circulated to prevent the amount of the laser gas containing a large amount of the discharge products from staying at a specific location in the chamber 10. (d) The laser gas in the chamber 10 is replaced with a new laser gas, and the laser gas containing the large amount of the discharge products is exhausted out of the chamber 10.

In U.S. Pat. No. 5,027,366, the following measures are taken: (e) The first optical path tube 12a between the chamber 10 and the window 10a and the first optical path tube 12b between the chamber 10 and the window 10b are provided with baffles 12c and 12d, respectively, which are plate-shaped parts each having an opening at the center thereof. Providing the baffles 12c and 12d reduces the momentum of dust-shaped discharge products scattered from the discharge space between the discharge electrodes 11a and 11b. (f) A purge gas is caused to flow to the vicinities of the windows 10a and 10b to prevent the discharge products from reaching the windows 10a and 10b.

The measures described above in (c) to (f) may suppress adhesion of the discharge products to the windows 10a and 10b, but the advantages of the measures is insufficient in some cases. In addition to the measures described above in (c) to (f), it has not been clarified whether there are other effective measures, and an approach of quantitatively evaluating the effectiveness of various measures has not been clarified.

The present applicant has found that the smaller sound pressure P of acoustic waves is in the vicinity of the windows 10a and 10b, the acoustic waves generated in the discharge space between the discharge electrodes 11a and 11b, the smaller the amount of the discharge products are transported along with the acoustic waves to the vicinities of the window 10a or 10b and adhere to the window 10a or 10b, and the greater the effect of suppression of the adhesion of the discharge products that is provided by the baffles 12c and 12d.

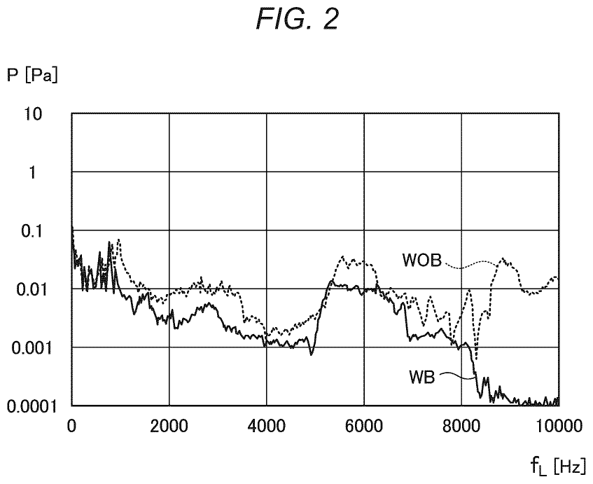

FIG. 2 shows graphs illustrating results of a simulation of the magnitude of the sound pressure P of the acoustic waves in the vicinities of the windows 10a and 10b in a case WOB, where the baffles 12c and 12d are not provided, and in a case WB, where the baffles 12c and 12d are provided. The horizontal axis represents a repetition frequency f_{L} of the laser light LB. The repetition frequency f_{L} coincides with the repetition frequency of the pulse discharge between the discharge electrodes 11a and 11b. The sound pressure reduction effect provided by the baffles 12c and 12d varies in accordance with the repetition frequency f_{L}, as shown in FIG. 2.

In a region where the repetition frequency f_{L} of the laser light LB to be output to an apparatus that processes polymer, glass, or any other material is 1 kHz or lower, it is believed that the sound pressure reduction effect provided by the baffles 12c and 12d is small, so that it is desired to take measures other than providing the baffles 12c and 12d. On the other hand, in a region where the repetition frequency f_{L} of the laser light LB to be output to a semiconductor exposure apparatus is 4 kHz or higher, the sound pressure reduction effect provided by the baffles 12c and 12d is expected. Even in the case WB, where the baffles 12c and 12d are provided, however, the sound pressure P is still high, so that further measures are desired. However, specific numerical values vary in some cases depending on the specific shapes of the baffles 12c and 12d and the chamber 10.

Each embodiment described below relates to reduction in the sound pressure P in the vicinities of the windows 10a and 10b in accordance with the repetition frequency f_{L} of the laser light LB and achievement of the effect of suppressing the adhesion of the discharge products.

### 2. Chamber Apparatus for Laser in which Resonance Vessels 16a and 16b are Connected to First Optical Path Tubes 12a and 12b Respectively

### 2.1 Configuration

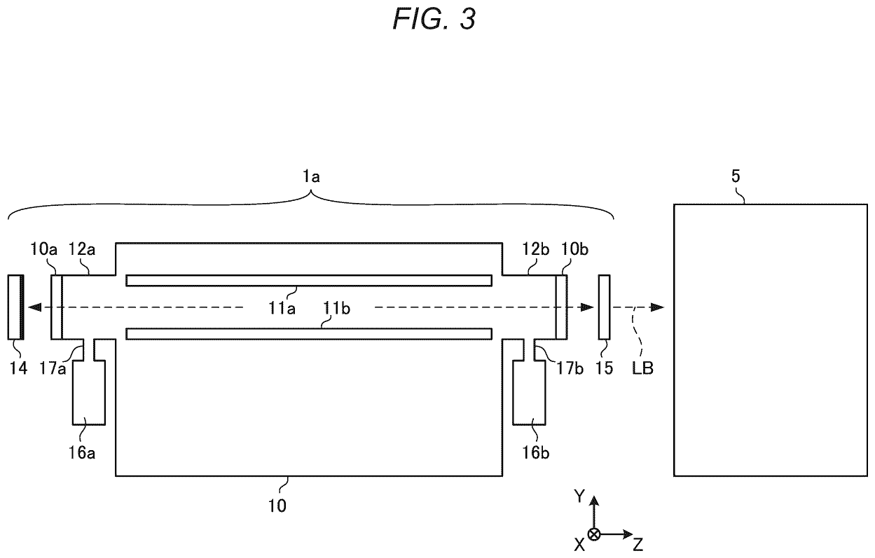

FIG. 3 shows the configuration of a laser processing system in a first embodiment. In the first embodiment, a laser apparatus 1a provided in the laser processing system includes resonance vessels 16a and 16b connected to the first optical path tubes 12a and 12b, respectively, in place of the baffles 12c and 12d. The first optical path tubes 12a and 12b communicate with the resonance vessels 16a and 16b via nozzle tubes 17a and 17b, respectively. The resonance vessel 16a and the nozzle tube 17a, and the resonance vessel 16b and the nozzle tube 17b each act as a Helmholtz resonator.

The chamber 10, the first optical path tubes 12a and 12b, the windows 10a and 10b, the resonance vessels 16a and 16b, the nozzle tubes 17a and 17b constitute the chamber apparatus for a laser according to the present disclosure. The chamber apparatus for a laser is not necessarily used in a laser oscillator, and may be used in a laser amplifier.

### 2.2 Helmholtz Resonance Frequency f

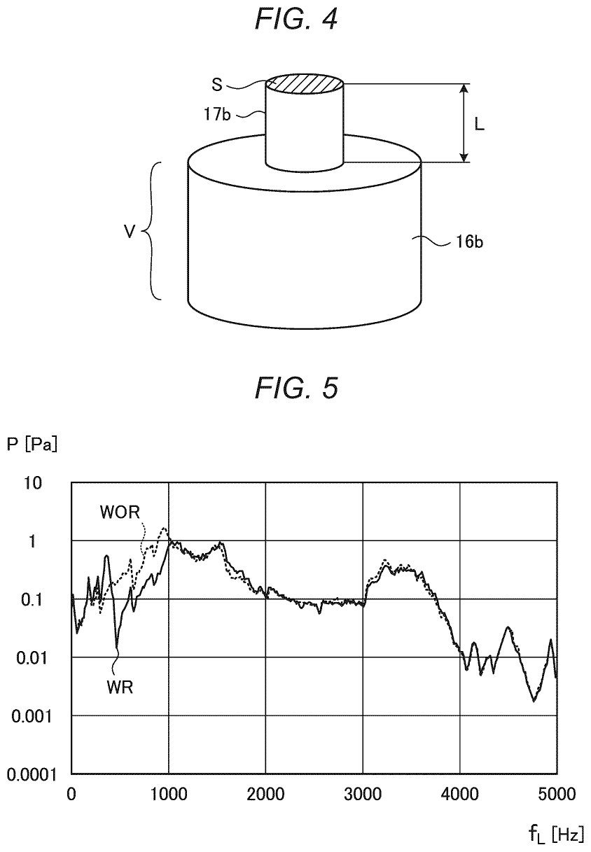

FIG. 4 shows various parameters that determine a Helmholtz resonance frequency f. The Helmholtz resonance frequency f is expressed by the following expression, where V represents the volume of the resonance vessel 16b, L represents the length of the nozzle tube 17b, S represents the cross-sectional area of the nozzle tube 17b, and c represents the sound speed.

$$f = ( c / 2 π ) {( S / VL )}^{1 / 2}$$

The same applies to the resonance vessel 16a and the nozzle tube 17a.

Connecting the Helmholtz resonators to the first optical path tubes 12a and 12b and matching the Helmholtz resonance frequency f to the repetition frequency f_{L} of the laser light LB allow suppression of the adhesion of the discharged product to the windows 10a and 10b.

FIG. 5 shows graphs illustrating results of a simulation of the magnitude of the sound pressure P of the sound waves in the vicinities of the windows 10a and 10b in a case WOR, where the Helmholtz resonators are not provided, and in a case WR, where the Helmholtz resonators are provided. The horizontal axis represents the repetition frequency f_{L} of the laser light LB. The volume V of each of the resonance vessels 16a and 16b, the length L and the cross-sectional area S of each of the nozzle tubes 17a and 17b are so set that the Helmholtz resonance frequency f is 500 Hz.

An excellent sound pressure reduction effect is achieved in the region where the repetition frequency f_{L} is higher than 450 Hz but lower than 550 Hz, as shown in FIG. 5. It is believed that even when the Helmholtz resonance frequency f is set at the other values, an excellent sound pressure reduction effect is achieved over a range of about 100 Hz. The volume V of each of the resonance vessels 16a and 16b, the length L and the cross-sectional area S of each of the nozzle tubes 17a and 17b are therefore so set that the Helmholtz resonance frequency f is higher than the value as a result of subtraction of 50 Hz from the repetition frequency f_{L} but is lower than the value as a result of addition of 50 Hz to the repetition frequency f_{L}. The setting described above can suppress the adhesion of the discharge products to the windows 10a and 10b.

### 2.3 Effects

(1) According to the first embodiment, the chamber apparatus for a laser includes the chamber 10, in which the pair of discharge electrodes 11a and 11b are disposed, the first optical path tube 12a or 12b, which communicates with the chamber 10, the window 10a or 10b, the resonance vessel 16a or 16b, and the nozzle tube 17a or 17b. The light is incident on the window 10a or 10b from the region between the discharge electrodes 11a and 11b via the interior of the first optical path tube 12a or 12b. The nozzle tube 17a or 17b causes the interior of the first optical path tube 12a or 12b to communicate with the resonance vessel 16a or 16b.

The configuration described above reduces the acoustic waves that reach the window 10a or 10b, so that the life of the window 10a or 10b can be extended.
(2) According to the first embodiment, the Helmholtz resonance frequency f determined by the resonance vessel 16a or 16b and the nozzle tube 17a or 17b is higher than the value as a result of subtraction of 50 Hz from the repetition frequency f_{L} of the laser light LB but is lower than the value as a result of addition of 50 Hz to the repetition frequency f_{L}.

According to the thus set Helmholtz resonance frequency f, a large acoustic wave reduction effect can be achieved over the range of ±50 Hz of the Helmholtz resonance frequency f.

The first embodiment may otherwise be the same as Comparative Example.

### 3. Chamber Apparatus for Laser in which First Unit 13c is Disposed in Second Optical Path Tube 20

### 3.1 Configuration

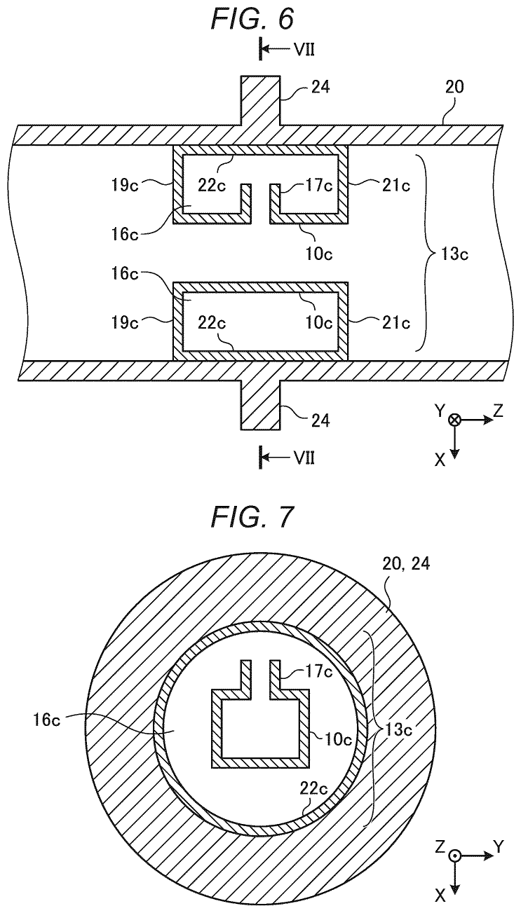

FIG. 6 shows the configuration of a Helmholtz resonator in a second embodiment. FIG. 7 is a cross-sectional view of the Helmholtz resonator taken along the line VII-VII in FIG. 6. In the second embodiment, a first optical path tube 10c, a resonance vessel 16c, and a nozzle tube 17c are housed in a second optical path tube 20. The second optical path tube 20 may be configured in the same manner as any one of the first optical path tubes 12a and 12b in the first embodiment, and holds any one of the windows 10a and 10b. The second optical path tube 20 may include a flange 24, which fixes the second optical path tube 20 in communication with the chamber 10. The second optical path tube 20 may be configured with the holder that holds the window 10a or 10b.

The resonance vessel 16c is the space surrounded by the first optical path tube 10c, a tube wall 22c, and first and second partition walls 19c and 21c. The resonance vessel 16c is disposed so as to surround the first optical path tube 10c. The first optical path tube 10c forms a portion of the optical path of the light traveling back and forth in the optical cavity. The inner surface of the first optical path tube 10c has a rectangular cross-sectional shape perpendicular to the direction in which the light passes. The nozzle tube 17c is disposed so as to protrude from the tube wall of the first optical path tube 10c toward the interior of the resonance vessel 16c. The first optical path tube 10c, the resonance vessel 16c, and the nozzle tube 17c are integrated into a first unit 13c, and the first unit 13c is fitted into the second optical path tube 20.

### 3.2 Effects

(3) According to the second embodiment, the chamber apparatus for a laser includes the second optical path tube 20. The second optical path tube 20 houses the first optical path tube 10c, the resonance vessel 16c, and the nozzle tube 17c, communicates with the chamber 10, and holds the window 10a or 10b.

The compact configuration described above, which houses the resonance vessel 16c and other elements in the second optical path tube 20, can reduce the acoustic waves.
(4) According to the second embodiment, the resonance vessel 16c is disposed so as to surround the first optical path tube 10c.

According to the configuration described above, the first optical path tube 10c is disposed in the vicinity of the center of the second optical path tube 20, through which the light output from the discharge space between the discharge electrodes 11a and 11b toward the window 10a or 10b passes, and the resonance vessel 16c is disposed around the first optical path tube 10c, so that the space in the second optical path tube 20 can be effectively used.
(5) According to the second embodiment, the inner surface of the first optical path tube 10c has a rectangular cross-sectional shape perpendicular to the Z direction, which is the direction in which the light passes.

According to the configuration described above, matching the cross-sectional shape of the first optical path tube 10c to the cross-sectional shape of the light output from the discharge space between the discharge electrodes 11a and 11b toward the windows 10a and 10b allows effective use of the space in the second optical path tube 20.
(6) According to the second embodiment, the nozzle tube 17c protrudes from the tube wall of the first optical path tube 10c toward the interior of the resonance vessel 16c.

The configuration described above can prevent the nozzle tube 17c from blocking the passage of the light output from the discharge space between the discharge electrodes 11a and 11b toward the windows 10a and 10b.
(7) According to the second embodiment, the first optical path tube 10c, the resonance vessel 16c, and the nozzle tube 17c are integrated into the first unit 13c.

The thus configured unit allows attachment and replacement as a unit.

The second embodiment may otherwise be the same as the first embodiment.

### 4. Chamber Apparatus for Laser in which Multiple First Units 13c to 13e are Disposed in Second Optical Path Tube 20

### 4.1 Configuration

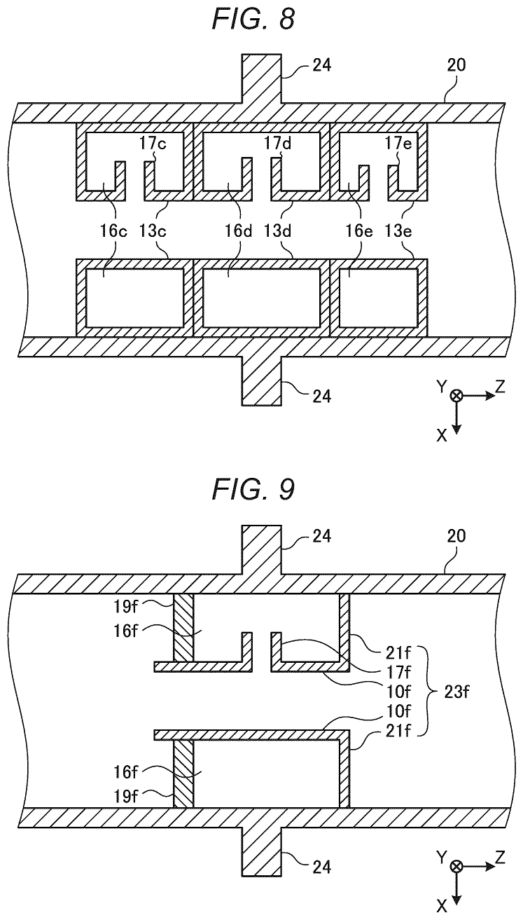

FIG. 8 shows the configuration of a Helmholtz resonator in a third embodiment. In the third embodiment, multiple first units 13c, 13d, and 13e are housed in the second optical path tube 20. The first units 13c, 13d, and 13e are arranged in the direction in which the light passes. The first units 13d and 13e may each be the same as the first unit 13c, and the reference character of each element of the first units 13c, 13d, and 13e is not shown in some cases in the drawings.

The first units 13c, 13d, and 13e desirably have Helmholtz resonance frequencies f different from each other. To configure the first units 13c, 13d, and 13e to have Helmholtz resonance frequencies f different from each other, resonance vessels 16c, 16d, and 16e of the first units 13c, 13d, and 13e may have volumes V different from each other. Instead, nozzle tubes 17c, 17d, and 17e may have lengths L different from each other, or may have inner diameters different from each other and therefore have cross-sectional areas S different from each other.

### 4.2 Effects

(8) According to the third embodiment, the multiple first units 13c to 13e are housed in the second optical path tube 20. The resonance vessel 16c and the nozzle tube 17c, the resonance vessel 16d and the nozzle tube 17d, and the resonance vessel 16e and the nozzle tube 17e are so configured that the first units 13c to 13e have Helmholtz resonance frequencies f different from each other.

According to the configuration described above, which includes Helmholtz resonators having Helmholtz resonance frequencies f different from each other, a situation in which the repetition frequency f_{L} of the laser light LB is changed can be handled.
(9) According to the third embodiment, the first units 13c to 13e include the resonance vessels 16c to 16e having volumes V different from each other.

According to the configuration described above, in which the volumes V of the resonance vessels 16c to 16e differ from each other, multiple Helmholtz resonance frequencies f can be achieved.
(10) According to the third embodiment, the first units 13c to 13e include the nozzle tubes 17c to 17e having lengths L different from each other.

According to the configuration described above, in which the lengths L of the nozzle tubes 17c to 17e differ from each other, multiple Helmholtz resonance frequencies f can be achieved. Rather than increasing the volumes V of the resonance vessels 16c to 16e, increasing the lengths L of the nozzle tubes 17c to 17e can suppress an increase in the entire volume of the first units 13c to 13e.
(11) According to the third embodiment, the first units 13c to 13e include the nozzle tubes 17c to 17e having inner diameters different from each other.

According to the configuration described above, in which the inner diameters of the nozzle tubes 17c to 17e differ from each other, multiple Helmholtz resonance frequencies f can be achieved. Rather than increasing the volumes V of the resonance vessels 16c to 16e or the lengths L of the nozzle tubes 17c to 17e, decreasing the inner diameters of the nozzle tubes 17c to 17e can suppress the entire volume of the first units 13c to 13e.
(12) According to the third embodiment, the first units 13c to 13e are housed in the second optical path tube 20, and the first units 13c to 13e are arranged in the Z direction, which is the direction in which the light passes.

According to the configuration described above, the outer shapes of the first units 13c to 13e can be the same in accordance with the shape of the second optical path tube 20.

The third embodiment may otherwise be the same as the second embodiment.

### 5. Chamber Apparatus for Laser in which Second Optical Path Tube 20 Defines Resonance Vessel 16f

### 5.1 Configuration

FIG. 9 shows a first example of the configuration of a Helmholtz resonator in a fourth embodiment. In the fourth embodiment, a resonance vessel 16f is the space surrounded by a first optical path tube 10f, the second optical path tube 20, and first and second partition walls 19f and 21f. The first and second partition walls 19f and 21f are partition walls that close the gap between the exterior of the first optical path tube 10f and the interior of the second optical path tube 20, respectively, at different positions in the direction in which the light passes.

The first optical path tube 10f, the second partition wall 21f, and a nozzle tube 17f are integrated into a second unit 23f, and the second unit 23f is fitted into the second optical path tube 20. The first optical path tube 10f passes through the first partition wall 19f in parallel to the direction in which the light passes. Moving the first optical path tube 10f and the second partition wall 21f in parallel to the direction in which the light passes with respect to the first partition wall 19f allows an increase or a decrease in the distance between the first partition wall 19f and the second partition wall 21f, so that the volume V of the resonance vessel 16f can be changed.

The space between the second partition wall 21f and the second optical path tube 20 and the space between the first partition wall 19f and the first optical path tube 10f may each be sealed, for example, with an O-ring or a gasket that is not shown.

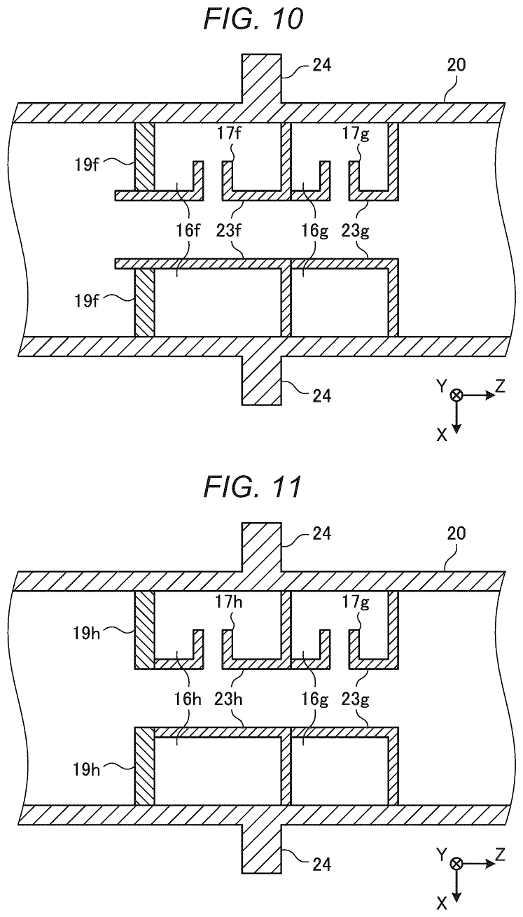

FIG. 10 shows a second example of the configuration of the Helmholtz resonator in the fourth embodiment. In the fourth embodiment, multiple second units 23f and 23g may be housed in the second optical path tube 20. The second units 23f and 23g are arranged in the direction in which the light passes. The second unit 23g may be the same as the second unit 23f, and the reference character of each element of the second units 23f and 23g are not shown in some cases in the drawings.

A resonance vessel 16g is the space surrounded by the second optical path tube 20 and the second units 23f and 23g. The configuration in which the second unit 23g is in contact with the second unit 23f fixes the volume V of the resonance vessel 16g.

### 5.2 Effects

(13) According to the fourth embodiment, the resonance vessel 16f is the space surrounded by the first optical path tube 10f, the second optical path tube 20, and the first and second partition walls 19f and 21f. The first and second partition walls 19f and 21f close the gap between the exterior of the first optical path tube 10f and the interior of the second optical path tube 20, respectively, at different positions in the Z direction, which is the direction in which the light passes.

According to the configuration described above, using the second optical path tube 20 as a portion of the wall that surrounds the resonance vessel 16f allows an increase in the volume of the resonance vessel 16f than in the first unit 13c in the second and third embodiments.
(14) According to the fourth embodiment, the first optical path tube 10f penetrates the first partition wall 19f in parallel to the Z direction, which is the direction in which the light passes. Moving the first optical path tube 10f and the second partition wall 21f in parallel to the Z direction with respect to the first partition wall 19f allows an increase or a decrease in the distance between the first partition wall 19f and the second partition wall 21f.

According to the configuration described above, the volume V of the resonance vessel 16f can be changed without replacement of the first optical path tube 10f or the first and second partition walls 19f and 21f. For example, the Helmholtz resonance frequency f can be changed in accordance with the operating conditions at the time of, for example, the laser processing, adjustment oscillation, and passivation.
(15) According to the fourth embodiment, the first optical path tube 10f, the second partition wall 21f, and the nozzle tube 17f are integrated into the second unit 23f.

The thus configured unit allows attachment and replacement as a unit.
(16) According to the fourth embodiment, the second units 23f and 23g are housed in the second optical path tube 20, and the second units 23f and 23g are arranged in the Z direction, which is the direction in which the light passes.

According to the configuration described above, the outer shapes of the second units 23f and 23g can be the same in accordance with the shape of the second optical path tube 20.

The fourth embodiment may otherwise be the same as the second or third embodiment.

### 6. Chamber Apparatus for Laser in which Volume V of Resonance Vessel 16h is Fixed

### 6.1 Configuration

FIG. 11 shows the configuration of a Helmholtz resonator in a fifth embodiment. In the fifth embodiment, multiple second units 23h and 23g are housed in the second optical path tube 20. The second unit 23h including a nozzle tube 17h does not penetrate a first partition wall 19h but is in contact with the first partition wall 19h, so that the volume V of a resonance vessel 16h is fixed.

The second units 23h and 23g desirably have Helmholtz resonance frequencies f different from each other. To configure the second units 23h and 23g to have Helmholtz resonance frequencies f different from each other, the resonance vessels 16h and 16g of the second units 23h and 23g may have volumes V different from each other. Instead, the nozzle tubes 17h and 17g may have lengths L different from each other, or may have inner diameters different from each other and therefore have cross-sectional areas S different from each other.

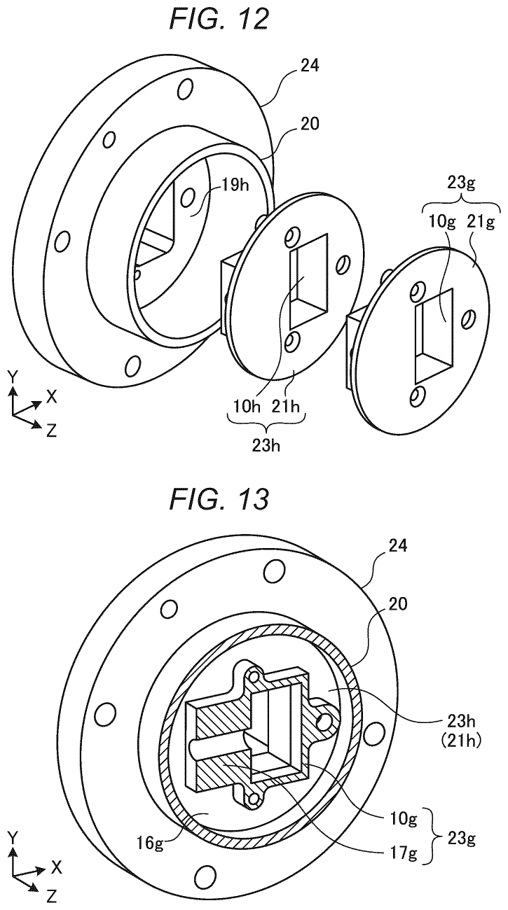

FIG. 12 shows a first specific configuration of the Helmholtz resonator in the fifth embodiment. FIG. 13 shows the second optical path tube 20 and the second unit 23g taken in a plane perpendicular to the traveling direction of the light in the first specific configuration. The second unit 23h including a first optical path tube 10h and a second partition wall 21h and the second unit 23g including a first optical path tube 10g and a second partition wall 21g are inserted into the second optical path tube 20 in which the first partition wall 19h is disposed to form the resonance vessels 16h and 16g shown in FIG. 11. The second partition wall 21h also serves as a first partition wall that defines the resonance vessel 16g. In the first specific configuration, the second units 23h and 23g form two resonators.

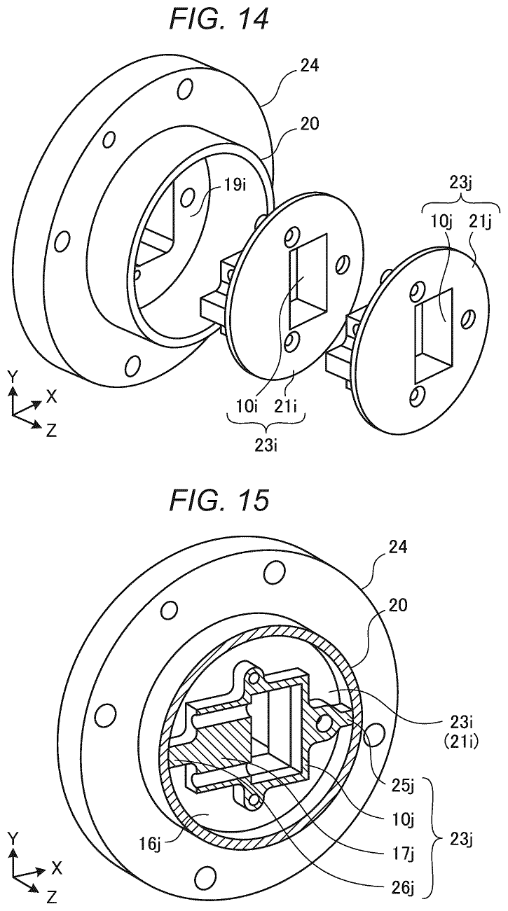

FIG. 14 shows a second specific configuration of the Helmholtz resonator in the fifth embodiment. FIG. 15 shows the second optical path tube 20 and a second unit 23j are taken in a plane perpendicular to the traveling direction of the light in the second specific configuration. A second unit 23i including a first optical path tube 10i and a second partition wall 21i and the second unit 23j including a first optical path tube 10j and a second partition wall 21j are inserted into the second optical path tube 20 in which a first partition wall 19i is disposed. The second partition wall 21i also serves as a first partition wall that defines a resonance vessel 16j.

The second unit 23j includes partitions 25j and 26j, which divide the space surrounded by the first optical path tube 10j, the second optical path tube 20, the second partition wall 21i, which also serves as the first partition wall, and the second partition wall 21j, into multiple rooms. A nozzle tube 17j is configured to cause the interior of the first optical path tube 10j to communicate with each of the multiple rooms. The same holds true for the second unit 23i. In the second specific configuration, the resonance vessel configured with each of the second units 23i and 23j is divided into two rooms, so that four rooms in total are formed.

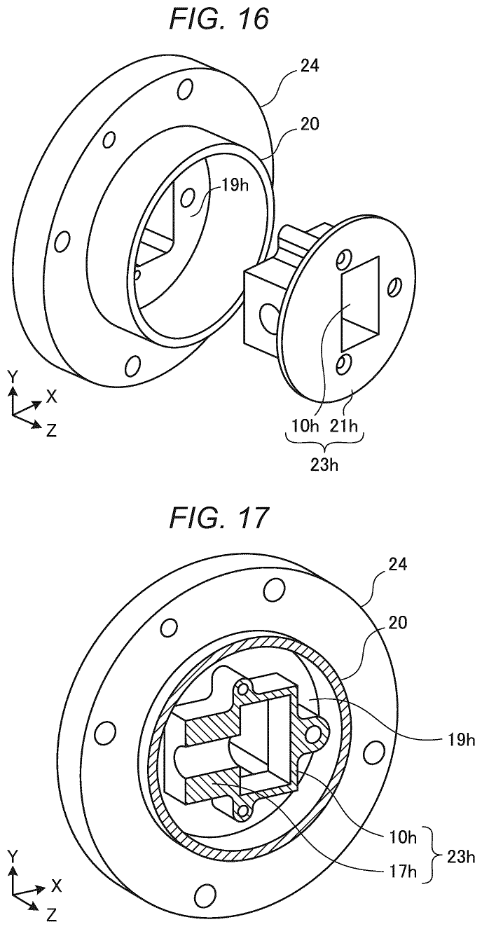

FIG. 16 shows a third specific configuration of the Helmholtz resonator in the fifth embodiment. FIG. 17 shows the second optical path tube 20 and the second unit 23h taken in a plane perpendicular to the traveling direction of the light in the third specific configuration. The second unit 23h is inserted into the second optical path tube 20 in which the first partition wall 19h is disposed. In the third specific configuration, the second unit 23h forms one resonator.

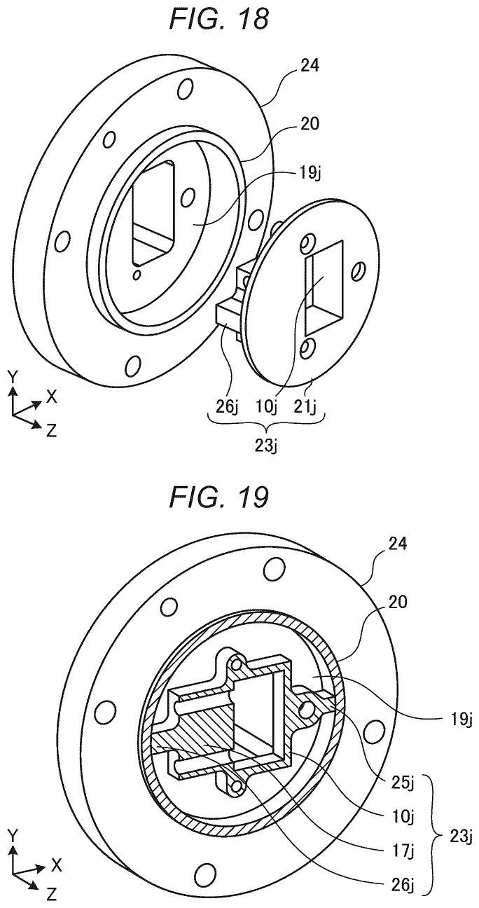

FIG. 18 shows a fourth specific configuration of the Helmholtz resonator in the fifth embodiment. FIG. 19 shows the second optical path tube 20 and the second unit 23j taken in a plane perpendicular to the traveling direction of the light in the fourth specific configuration. The second unit 23j is inserted into the second optical path tube 20 in which a first partition wall 19j is disposed. In the fourth specific configuration, the resonance vessel configured with the second unit 23j is divided into two rooms.

### 6.2 Effects

(17) According to the fifth embodiment, the multiple second units 23h and 23g are housed in the second optical path tube 20. The resonance vessel 16h and the nozzle tube 17h, and the resonance vessel 16g and the nozzle tube 17g are so configured that the second units 23h and 23g have Helmholtz resonance frequencies f different from each other.

According to the configuration described above, which includes Helmholtz resonators having Helmholtz resonance frequencies f different from each other, a situation in which the repetition frequency f_{L} of the laser light LB is changed can be handled.
(18) According to the second specific configuration of the fifth embodiment, the second unit 23j includes the partitions 25j and 26j. The partitions 25j and 26j divide the space surrounded by the first optical path tube 10j, the second optical path tube 20, the second partition wall 21i, which also serves as the first partition wall, and the second partition wall 21j, into multiple rooms. The nozzle tube 17j is configured to cause the interior of the first optical path tube 10j to communicate with each of the multiple rooms.

According to the configuration described above, the resonance vessel can be divided into multiple rooms for Helmholtz resonance.

The fifth embodiment may otherwise be the same as the fourth embodiment.

### 7. Others

7.1 Electronic device including interposer IP

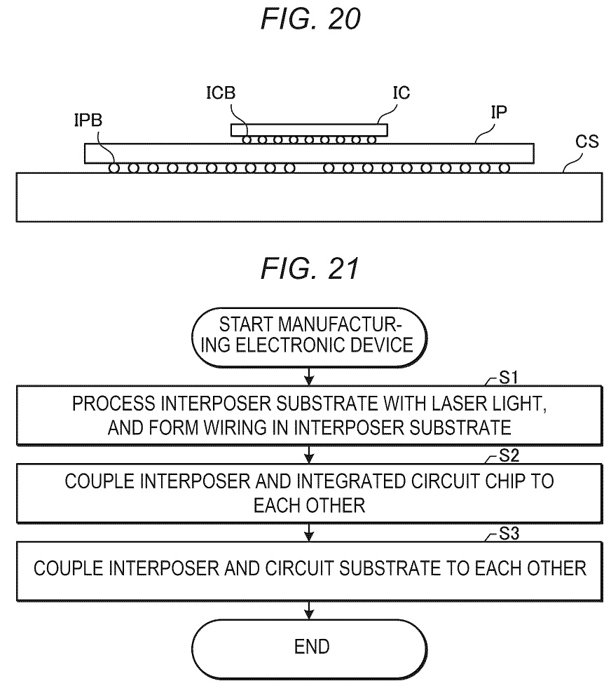

FIG. 20 diagrammatically shows the configuration of an electronic device. The electronic device shown in FIG. 20 includes an integrated circuit chip IC, an interposer IP, and a circuit substrate CS.

The integrated circuit chip IC is, for example, a chip in which an integrated circuit that is not shown is formed in a silicon substrate. The integrated circuit chip IC is provided with multiple bumps ICB to be electrically connected to the integrated circuit.

The interposer IP includes an insulating substrate in which multiple through holes that are not shown are formed, and an electrical conductor that is not shown but electrically connects the front and rear sides of the substrate to each other is provided in each of the through holes. Multiple lands that are not shown but are connected to the bumps ICB are formed at one surface of the interposer IP, and the lands are each electrically connected to one of the electrical conductors in the through holes. Multiple bumps IPB are provided at the other surface of the interposer IP, and the bumps IPB are each electrically connected to one of the electrical conductors in the through holes.

Multiple lands that are not shown but are connected to the bumps IPB are formed at one surface of the circuit substrate CS. The circuit substrate CS includes multiple terminals to be electrically connected to the lands.

FIG. 21 is a flowchart showing a method for manufacturing the electronic device. In S1, an interposer substrate, which constitutes the interposer IP, is processed with laser light, and wiring is formed in the interposer substrate. The laser processing performed on the interposer substrate includes forming the through holes by irradiating the interposer substrate with the laser light LB. The wiring formation includes forming an electrically conductive film at the inner wall surface of each of the through holes formed in the interposer substrate. The interposer IP is produced through the steps described above.

In S2, the interposer IP and the integrated circuit chip IC are coupled to each other. Step S2 includes, for example, placing the bumps ICB of the integrated circuit chip IC on the lands of the interposer IP, and electrically connecting the bumps ICB to the lands.

In S3, the interposer IP and the circuit substrate CS are coupled to each other. Step S3 includes, for example, placing the bumps IPB of the interposer IP on the lands of the circuit substrate CS, and electrically connecting the bumps IPB to the lands.

### 7.2 Supplements

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious for those skilled in the art that embodiments of the present disclosure would be appropriately combined.

The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, the term “at least one of A, B, and C” should be interpreted to mean any of A, B, C, A+B, A+C, B+C, and A+B+C. Moreover, the term described above should be interpreted to include combinations of any thereof and any other than A, B, and C.

What is claimed is:

1. A chamber apparatus for a laser, the chamber apparatus comprising:
a chamber in which a pair of discharge electrodes are disposed;
a first optical path tube that communicates with the chamber;
a window configured such that light is incident thereon from a region between the discharge electrodes via an interior of the first optical path tube;
a resonance vessel; and
a nozzle tube configured to cause the interior of the first optical path tube to communicate with the resonance vessel.

2. The chamber apparatus for a laser according to claim 1, wherein
a Helmholtz resonance frequency determined by the resonance vessel and the nozzle tube is greater than a value as a result of subtraction of 50 Hz from a repetition frequency of pulse discharge between the discharge electrodes but smaller than a value as a result of addition of 50 Hz to the repetition frequency.

3. The chamber apparatus for a laser according to claim 1, further comprising
a second optical path tube configured to house the first optical path tube, the resonance vessel, and the nozzle tube, communicate with the chamber, and hold the window.

4. The chamber apparatus for a laser according to claim 3, wherein
the resonance vessel is disposed so as to surround the first optical path tube.

5. The chamber apparatus for a laser according to claim 3, wherein
an inner surface of the first optical path tube has a rectangular cross-sectional shape perpendicular to a direction in which the light passes.

6. The chamber apparatus for a laser according to claim 3, wherein
the nozzle tube protrudes from a tube wall of the first optical path tube toward an interior of the resonance vessel.

7. The chamber apparatus for a laser according to claim 3, wherein
the first optical path tube, the resonance vessel, and the nozzle tube are integrated into a first unit.

8. The chamber apparatus for a laser according to claim 7, wherein
a plurality of the first units are housed in the second optical path tube, and
the resonance vessels and the nozzle tubes are so configured that the first units have Helmholtz resonance frequencies different from each other.

9. The chamber apparatus for a laser according to claim 8, wherein
the resonance vessels of the first units have volumes different from each other.

10. The chamber apparatus for a laser according to claim 8, wherein
the nozzle tubes of the first units have lengths different from each other.

11. The chamber apparatus for a laser according to claim 8, wherein
the nozzle tubes of the first units have inner diameters different from each other.

12. The chamber apparatus for a laser according to claim 7, wherein
the first units are housed in the second optical path tube, and
the first units are arranged in a direction in which the light passes.

13. The chamber apparatus for a laser according to claim 3, wherein
the resonance vessel is a space surrounded by
the first optical path tube,
the second optical path tube, and
first and second partition walls configured to close a gap between an exterior of the first optical path tube and an interior of the second optical path tube at different positions in a direction in which the light passes.

14. The chamber apparatus for a laser according to claim 13, wherein
the first optical path tube penetrates the first partition wall in parallel to the direction in which the light passes, and moving the first optical path tube and the second partition wall in parallel to the direction in which the light passes with respect to the first partition wall allows an increase or a decrease in a distance between the first partition wall and the second partition wall.

15. The chamber apparatus for a laser according to claim 13, wherein
the first optical path tube, the second partition wall, and the nozzle tube are integrated into a second unit.

16. The chamber apparatus for a laser according to claim 15, wherein
a plurality of the second units are housed in the second optical path tube, and
the multiple second units are arranged in the direction in which the light passes.

17. The chamber apparatus for a laser according to claim 15, wherein
the second unit is configured with multiple second units housed in the second optical path tube, and
the resonance vessel and the nozzle tubes are so configured that the second units have Helmholtz resonance frequencies different from each other.

18. The chamber apparatus for a laser according to claim 15, wherein
the second unit includes a partition configured to divide the space surrounded by the first optical path tube, the second optical path tube, the first partition wall, and the second partition wall into multiple rooms,
the nozzle tube is configured to cause the interior of the first optical path tube to communicate with each of the multiple rooms.

19. A laser apparatus comprising:
an optical cavity; and
the chamber apparatus for a laser according to claim 1 in which the window is located in an optical path of the optical cavity.

20. An electronic device manufacturing method comprising:
generating laser light by using a laser apparatus;
performing laser processing on an interposer substrate with the laser light to produce an interposer;
coupling the interposer to an integrated circuit chip to electrically connect the interposer to the integrated circuit chip; and
coupling the interposer to a circuit substrate to electrically connect the interposer to the circuit substrate,
the laser apparatus including,
an optical cavity,
a chamber in which a pair of discharge electrodes are disposed,
a first optical path tube that communicates with the chamber;
a window that is located in an optical path of the optical cavity, the window being configured such that light is incident thereon from a region between the discharge electrodes via an interior of the first optical path tube,
a resonance vessel; and
a nozzle tube configured to cause the interior of the first optical path tube to communicate with the resonance vessel.
